(19) United States
(12) Patent Application Publication
(10) Pub. No.: US 2005/0055629 A1
(43) Pub. Date: Mar. 10, 2005

(54) Method and mechanism for efficient access to nodes in XML data

(75) Inventors: Bhushan Khaladkar, Mountain View, CA (US); Reema Koo, Los Altos, CA (US); Nipun Agarwal, Santa Clara, CA (US); Ravi Murthy, Fremont, CA (US); Eric Sedlar, San Francisco, CA (US)

Correspondence Address: BINGHAM, MCCUTCHEN LLP, THREE EMBARCADERO, SUITE 1800, SAN FRANCISCO, CA, 94111-4067, US

(73) Assignee: Oracle International Corporation, Redwood Shores, CA (US)

(21) Appl. No.: 10/656,097

(22) Filed: Sep. 5, 2003

(51) Int. Cl. G06F 17/00

(52) U.S. Cl. 715/513

(57) ABSTRACT

Disclosed is a method and mechanism for accessing XML data. In one approach, in the case of a schema based document, the structure of the XML document is known apriori and this information can be exploited to store and retrieve the data more efficiently. A Named Access interface or procedure can be defined and associated with elements of the schema. The need for datatype conversions can be eliminated by allowing direct mapping to the intended datatype or the closest matching datatype in the system to which the invention is directed. The storage information can be exploited to provide “direct” access to data based on offset in lieu of a linear traversal. Another aspect is that only the relevant portions need to be even loaded into memory.

### COPYRIGHT NOTICE

This document contains computer code and other material which are subject to copyright protection. The copyright owner has no objection to the facsimile reproduction of these materials as they appear in the United States Patent and Trademark patent files or records, but otherwise reserves all copyright rights whatsoever.

### BACKGROUND AND SUMMARY

The invention relates to a method and mechanism for efficiently accessing XML data.

The extensible markup language (XML) is a meta-language developed and standardized by the World Wide Web Consortium (W3C) that permits use and creation of customized markup languages for different types of documents. XML is a variant of and is based on the Standard Generalized Markup Language (SGML), the international standard meta-language for text markup systems that is also the parent meta-language for the Hyper-Text Markup Language (HTML). Since its adoption as a standard language, XML has become widely used to describe and implement many kinds of document types.

XML data that is persistently stored can be accessed in a variety of ways. XML documents can be either schema based or non-schema based. The W3C Document Object Model (DOM) is a platform- and language-neutral interface standard that allows programs and scripts to dynamically access and update the content, structure and style of XML documents. When XML documents are accessed, either the entire document is retrieved or a part of the document (e.g., element or attribute) is retrieved. The document can be further processed and the results of that processing can be incorporated back into the presented page.

The DOM API is a popular standard that is used to provide a piecewise access to XML data. In general, the DOM API provides piecewise access to elements of XML data by progressively walking through the elements of the data. To illustrate, consider the following example XML schema:

<schema xmlns=“http://www.w3.org/2001/XMLSchema”

<element name = “Employee”>

<complexType>
<sequence>

<element name = “EmployeeId” type = “positiveInteger”/>
<element name = “FirstName” type = “string”/>
<element name = “LastName” type = “string”/>
<element name = “Salary” type = “positiveInteger”/>

</sequence>
</complexType>

</element>

</schema>

FIG. 1 logically illustrates the structure implicit in this schema. In this structure, the element “Employee” represents the parent node. The child nodes to node Employee are nodes “Employeeld”, “FirstName”, “LastName”, and “Salary”.

In the standard DOM API approach to access a child node element in this schema, a progression of DOM-based getFirstChild and getNextChild operations are performed to access a data element within the XML data. For example, assume that it is desired to access the LastName element of an item of XML data in this Employee schema. The DOM API approach would start at the parent node and perform a getFirstChild operation to determine whether the first child node of the parent Employee node corresponds to the desired data element. Here, the first child node does not reference the desired LastName data element, since the first child node corresponds to the “Employeeld” element. Therefore, a getNextChild operation is performed to progressively walk to the next child node to determine whether the next child node corresponds to the desired LastName element. The next child node that is accessed does not reference the desired LastName element, since the next child node corresponds to the “FirstName” element. This process continues until the desired child element is eventually identified and the data can be accessed, i.e., when the getNextChild operation reaches the LastName node.

Therefore, the DOM API essentially uses a trial and error approach that could be relatively inefficient and time-expensive, with the efficiency of the data access particularly dependent upon the exact position of the desired data element in the schema relative to the parent node. Moreover, DOM implementations normally store the XML in memory as a linked list of some sort that is typically in document order. This leads to increased memory usage and slow traversal of the DOM to get to a specific child.

The Java Architecture for XML Bind (JAXB) is an emerging standard that provides an API and tools to automate the mapping between XML documents and Java objects. However, to date, the JAXB standard has merely provided suggestions for a common interface to perform piecewise access of XML data, and has not provided improved implementing technology to perform this access and correct these deficiencies of the DOM API.

Therefore, there is a need for an improved method and mechanism for accessing elements within XML data. In one embodiment of the invention, in the case of a schema based document, the structure of the XML document is known apriori and this information can be exploited to store and retrieve the data more efficiently. A Named Access interface or procedure can be defined and associated with elements of the schema. Access to a node of the XML document can be obtained by directly accessing the underlying data location, e.g., a column in a database, at which that node is stored as opposed to traversing a larger subset of the document. The need for datatype conversions can be eliminated by allowing direct mapping to the intended datatype or the closest matching datatype in the system to which the invention is directed. This is a distinct advantage over conventional approaches in which the data would be mapped from the datatype to a string for storage and later from a string to the datatype during retrieval. The storage information can be exploited to provide “direct” access to data based on offset in lieu of a linear traversal. Another aspect of an embodiment of this approach is that only the relevant portions need to be even loaded into memory, which enables better lazy manifestation. For example, if the element of interest is the last child of the parent, a bean accessor method based on this approach will avoid having to traverse through all the previous children.

Further details of aspects, objects, and advantages of the invention are described below in the detailed description, drawings, and claims.

### BRIEF DESCRIPTION OF THE DRAWINGS

The accompanying drawings are included to provide a further understanding of the invention and, together with the Detailed Description, serve to explain the principles of the invention. The same or similar elements in the figures may be referenced using the same reference numbers.

FIG. 1 shows an example XML schema.

FIG. 2 is a flowchart of a process for associating XML data elements with Named Access procedures according to an embodiment of the invention.

FIG. 3 is a flowchart of a process for accessing XML data according to an embodiment of the invention.

FIG. 4 illustratively shows how XML data elements are accessed according to an embodiment of the invention.

FIG. 5 is a diagram of a computer system with which the present invention can be implemented.

### DETAILED DESCRIPTION

The present invention provides an approach for accessing XML data that solves the problems of the DOM API approach. In one embodiment, in the case of a schema based document, the structure of the XML document is known apriori and this information can be exploited to store and retrieve the data more efficiently. One approach that can be taken is to improve the access performance of schema based documents via bean-style access.

An XML Schema defines the structure of its related XML documents. When an XML document is said to conform to a particular schema, its structure is well known in advance because of the defined schema. According to an embodiment of the invention, knowledge of the schema is used to provide direct access to elements within an XML document. Because the schema is known, access characteristics of a child element, such as its offset position relative to the parent node, can be determined. Therefore, if it is desired to access a particular element within the XML document, the access procedure can directly go to the properly identified offset position within the document and retrieve the appropriate amount of data corresponding to the desired element.

When implementing a “Named Access” approach, specifically named procedures or accessors (collectively referred to herein as “procedures”) are defined to access a particular XML element child or an attribute by its Name. For example, given a XML document <a><b>3</b></a>, consider if it is desired to create a Named Access procedure to access the value of the “b” child of “a”. In this scenario, the known schema for this document type would be used to identify the appropriate information to define a Named Access procedure for the Named Access procedure, which could be named, for example, getb( ). The getb( ) procedure would directly access the value of “b” at its relative position without requiring an extensive and progressive traversal of the document. Similarly, consider if it is desired to create a Named Access procedure to modify the value of the “b” child. Here, based upon this same schema information, such a procedure can defined and named, for example, setb( ). The setb( ) procedure would directly allow modification of the value of “b” at its relative position in the document without requiring an extensive and progressive traversal of the document to reach the “b” child.

It is noted that this is quite different from the conventional DOM API approach to this type of XML access, which would typically involve extensive levels of action to accomplish the same tasks. For example, in the typical DOM API approach to access the “b” element, the first step would require the system to get the children of “a” until the appropriate child has been reached. This is in contrast to the present approach, which allows direct named access to the correct child element. Therefore, one benefit of the present embodiment is that callers can directly get the value of the desired child element “b”, irrespective of exactly where the “b” element is present within “a”.

Furthermore, in the conventional DOM API approach, when this progression of “get” operations eventually causes reaches the correct child element, the string value of the child element must be converted into the appropriate datatype that may be used for or associated with the element. This is because the standard W3C DOM API uses strings to get and set the document data. This type of data conversion operation is inefficient if it introduces another layer of unneeded operations into the system.

In an embodiment of the invention, the “Named Access” procedure returns the appropriate datatype of the element child/attribute, so the generated interfaces for a particular language can map the XML Schema datatypes to the closest supported datatypes. This provides the benefit that the callers of the procedure can directly obtain the XML data from the native storage without converting to string and vice versa.

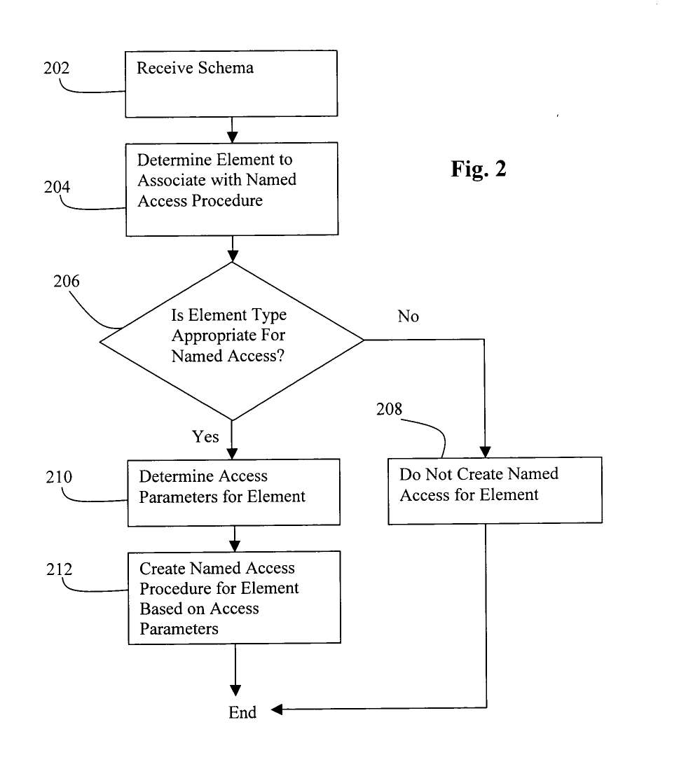

FIG. 2 shows a flowchart of a process for implementing direct access to elements within an XML document according to an embodiment of the invention. At 202, the schema for a document type of interest is received.

At 204, a decision is made to associate a particular element within the schema with direct Named Access. In the present approach, any or all of the eligible elements within the schema may be associated with a direct Named Access procedure.

At 206, a determination is made whether the selected element is appropriate for association with direct Named Access. Certain types of elements within an XML document may be designated as not eligible for Named Access. According to the present embodiment, all native datatypes are eligible to be registered for Named Access; however, data having the type “ANY” or DOM nodes which are not included in the XML schema are not eligible to registered with a Named Access procedure. If the selected element is not eligible, then the element is not registered (208).

If the selected element is eligible for registration, then the schema is analyzed to determine the appropriate access parameters for direct access to that element within the XML document (210). Examples of parameters that may be identified include the relative offset of the element within the document and the length of the element data. An additional parameter that may be identified includes the datatype of the selected element.

At 212, one or more Named Access procedures are created to provide direct access to the selected element within the XML document. Examples of Named Access procedures that can be created include the “get” and “set” procedures. The get procedure obtains the value of an element and the set procedure modifies or sets the value of the element. These procedures are created based upon the access parameters identified at 210. For example, the relative offset of the element, which was defined at 210, provides the relative location within the XML document that these named access procedures will access to directly get or set the value of the element. It is noted that the get and set procedures are merely examples of such procedures—other types of Named Access procedures may also be defined and created at 212.

The Named Access procedure can use the schema information regarding the type pf the element data to generate get/set methods that use the appropriate datatypes instead of strings. For example, if the XML schema specifies the type to be integer, the procedure implementation can store the data value as an integer to avoid conversion from integer to string and vice versa.

Therefore, it can be seen that the present Named Access approach, since callers always specify the name of the child they are interested in, the memory layout of the XML document can be much more efficient. No document order lists are required. In addition, an element can have a flat layout with all its children at some well known offset from the parent address. The mapping of name to offset can be managed independently of the XML document since the XML schema for the document is fixed. Using this approach, the name can be translated to a child very fast. Additionally, the flat layout also leads to the memory usage efficiencies.

It is noted that the process of FIG. 2 can be performed prior to, during, or after any of the XML instances are stored in the system/database. Moreover, the interfaces may be generated in any appropriate language, e.g., java.

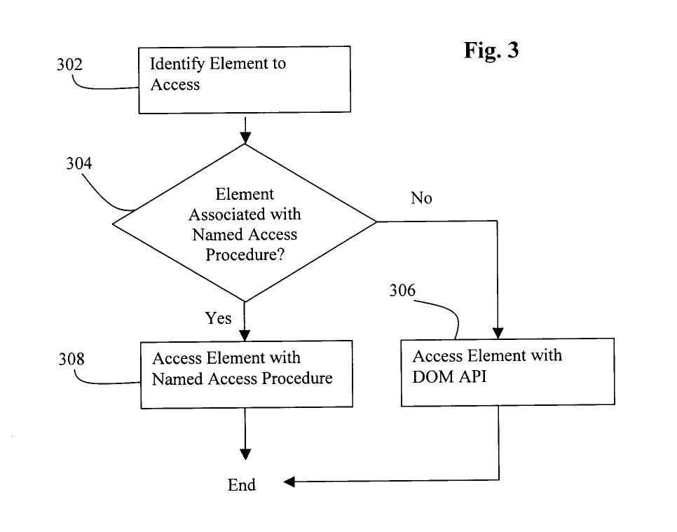

FIG. 3 shows a flowchart of a process for performing direct access to elements within an XML document according to an embodiment of the invention. At 302, identification is made of the specific element to access within an instance of the relevant XML document type.

A determination is made whether the element has been associated with an appropriate Named Access procedure for the desired access operation (304). For example, if it is desired to set the value of the element, then the determination is made whether an appropriate “set” procedure has been defined and associated with the element. Similarly, if it is desired to obtain the value of the element, then the determination is made whether an appropriate “get” procedure has been defined and associated with the element.

As noted above, not all element types are eligible to be associated with a Named Access procedure. In an embodiment, the Get/Set procedure/API can be defined for elements that return native datatypes for all element children/attributes. However, in the present embodiment, ineligible elements are those that are defined to be an ‘any’ type by the schema or which are DOM Nodes for all extra data not included in the schema, such as processing instructions and comments.

If the identified element to access has been associated with an appropriate Named Access procedure, then that procedure is used to perform a direct access to the element value in the XML document instance (308). If the identified element to access has not been associated with an appropriate Named Access procedure, then the default DOM API approach is used to access the element value (306).

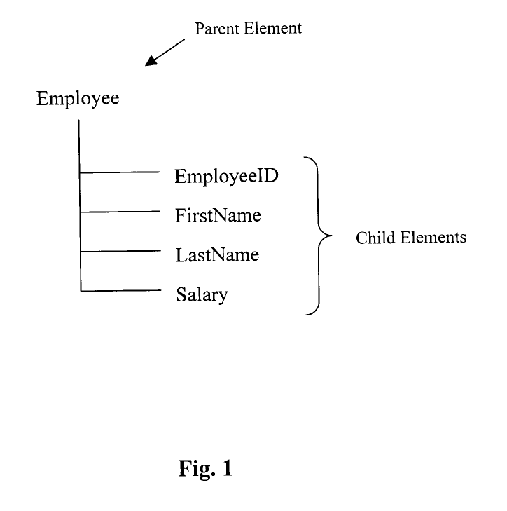

To illustrate these aspects of the invention, reference is made to the example schema represented by FIG. 1. Recall that FIG. 1 shows the hierarchical structure for the following schema:

<schema xmlns=“http://www.w3.org/2001/XMLSchema”

<element name = “Employee”>

<complexType>
<sequence>

<element name = “EmployeeId” type = “positiveInteger”/>
<element name = “FirstName” type = “string”/>
<element name = “LastName” type = “string”/>
<element name = “Salary” type = “positiveInteger”/>

</sequence>
</complexType>

</element>

</schema>

This schema includes a parent node “Employee” that has four child elements/attributes. The first child element is the “Employeeld” element which is of type “positive integer”. The second child element is the “FirstName” element which is of type “string”. The third child element is the “LastName” element which is also of type “string”. The fourth child element is the “Salary” element which is of type “positive integer”.

The procedures to get and set the EmployeeId( ) element can be called, for example, getEmployeeId( ) and setEmployeeId( ). Based upon the disclosed schema, these Named Access procedures can be defined to provide an interface/API that proceeds directly to the correct relative offset within an instance of the XML document to obtain or set the value for the EmployeeID element.

The procedures to get and set the FirstName element can be called, for example, getFirstName( ) and setFirstName( ). Based upon the disclosed schema, these Named Access procedures can be defined to provide an interface/API that proceeds directly to the correct relative offset within an instance of the XML document to obtain or set the value for the FirstName element. Since this is the second child element, these procedures will proceed to the correct relative offset within the Employee instance to directly access the FirstName value, e.g., based upon the length of the first child element EmployeeId.

Similarly, the procedures to get and set the LastName and Salary elements can be called, for example, getLastName( )/setLastName( ) and getSalary( )/setSalary( ), respectively. Based upon the disclosed schema, these Named Access procedures can be defined to provide an interface/API that proceeds directly to the correct relative offset within an instance of the XML document to obtain or set the value for these elements. Since these are the third and fourth child elements, these procedures will proceed to the correct relative offset within the Employee instance to directly access the FirstName value, e.g., based upon the length of the first and second child elements for the offset for LastName and based upon the length of the first, second, and third child elements for the offset for the Salary.

Below is an example of the corresponding Bean that can be generated for this schema to represent the Named Access procedures to get and set these child elements:

import org.w3c.dom.*;
import java.util.Date;
import java.math.BigDecimal;
import java.util.Vector;
import java.sql.*;
public class Employee
{

public Employee(XDBDocument owner, long xob)
{

super(owner, xob, 0);

}
public Employee(XDBDocument owner)
{

super(owner, 0);
setNodeXob(2442);

}
public Employee( )
{

super(null, 0, 0);

}
public BigDecimal getEmployeeId( )
{

return getScalarBigDecimal(0);

}
public void setEmployeeId(BigDecimal val)
{

setScalar(0, val);
return;

}
public String getFirstName( )
{

return getScalarString(1);

}
public void setFirstName(String val)
{

setScalar(1, val);
return;

}
public String getLastName( )
{

return getScalarString(2);

}
public void setLastName(String val)
{

setScalar(2, val);
return;

}
public BigDecimal getSalary( )
{

return getScalarBigDecimal(3);

}
public void setSalary(BigDecimal val)
{

setScalar(3, val);
return;

}

}

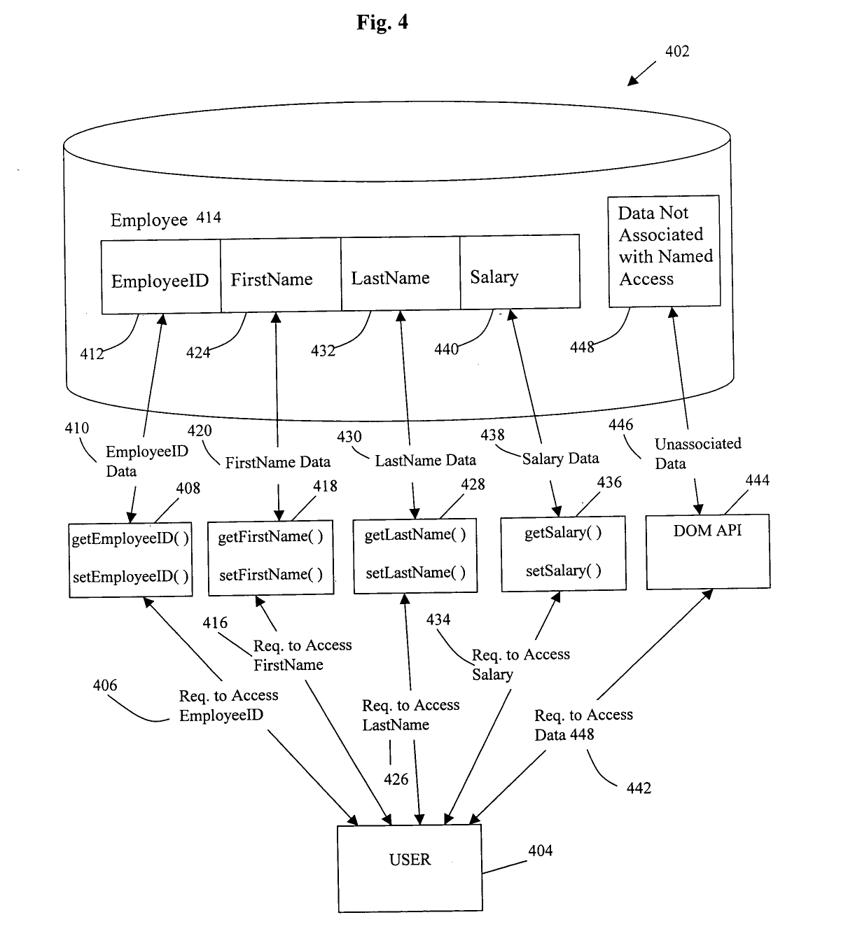

FIG. 4 graphically illustrates how these example Named Access procedures are used in contemplated practice. Assume that one or more instances 414 of this XML document type are to be stored in a storage system 402. As set forth above, each instance 414 of Employee includes an EmployeeID element 412, FirstName element 424, LastName element 432, and Salary element 440. The storage system 402 also includes a data element 448 that has not been associated with any Named Access procedures.

When a user 404 issues a request 406 to access the EmployeeID element 412 of instance 414, a determination is made whether this element is associated with an appropriate Named Access procedure for the requested operation. Here, it can be seen that Named Access procedures getEmployeeID( ) and setEmployeeID( ) 408 have been rassociated with this element. Therefore, these procedures 408 will be used to get and set the data values 410 for the EmployeeID element 412—without having to use the default DOM API 444 that progressively scans the Employee object instance 414 for the correct child node 412.

When a user 404 issues a request 416 to access the FirstName element 424 of instance 414, a determination is made whether this element is associated with an appropriate Named Access procedure for the requested operation. Here, it can be seen that Named Access procedures getFirstName( ) and setFirstName( ) 418 have been associated with this element. Therefore, these procedures 418 will be used to directly get and set the data values 420 for the FirstName element 424—without having to use the default DOM API 444.

Similarly, when a user 404 issues a request 426 or 434 to access either the LastName element 432 or Salary element 440 of instance 414, a determination is made whether these elements are associated with appropriate Named Access procedures for the requested operations. Again, it can be seen that Named Access procedures getLastName( )/setLastName( ) 428 and getSalary ( )/setSalary( ) 436, respectively, have been associated with these elements. Therefore, these procedures will be used to directly get and set the data values 430 and 438.

If the user 404 issues a request 442 to access a data element 448 that has not been associated with a Named Access procedure, then the default DOM API 444 will be used to access the data 446 for this element type.

The following provide example code showing how the beans being used to access the example child elements:

Employee emp = (Employee)ctx.lookup(“resource/tkxms1d1.xml”);
System.out.println(“-- tkxms1d1.xml getTest:”);
System.out.println (“Get Employee:EmployeeId: ” +

emp.getEmployeeId( ));

System.out.println (“Get Employee:FirstName: ” +

emp.getFirstName( ));

System.out.println (“Get Employee:LastName: ” +

emp.getLastName( ));

System.out.println (“Get Employee:Salary: ” +

emp.getSalary( ));

System.out.println(“-- tkxms1d1.xml setTest:”);
System.out.println (“set Employee:EmployeeId: 1000” );
emp.setEmployeeId(new BigDecimal(“1000”));
System.out.println (“set Employee:FirstName: Ravi2 ” );
emp.setFirstName(“Ravi2”);
System.out.println (“set Employee:LastName: Murthy 2” );
emp.setLastName(“Murthy 2”);
System.out.println (“set Employee:Salary: 500” );
emp.setSalary(new BigDecimal(“500”));
ctx.bind(“resource/newtkxms1d1.xml”, emp);
Employee emp2 =

(Employee)ctx.lookup(“resource/newtkxms1d1.xml”);

System.out.println(“-- newtkxms1d1.xml getTest:”);
System.out.println (“EmployeeId: ” + emp2.getEmployeeId( ));
System.out.println (“FirstName: ” + emp2.getFirstName( ));
System.out.println (“LastName: ” + emp2.getLastName( ));
System.out.println (“Salary: ” + emp2.getSalary( ));

In this example code, a lookup operation is performed against an XML document called tkxms1d1.xml from the database. What is received back is a class called Employee which corresponds to the root element of the document. The example code uses the Named interfaces (i.e., getEmployeeID( ), getFirstName( ), getLastName( ), and getSalary( )) to print the values of the children of the Employee element. It then uses the set( ) counterparts (i.e., setEmployeeID( ), setFirstName( ), setLastName( ), and setSalary( )) to modify the values of the children and then saves the document back to the database using the bind( ) method.

Therefore, what has been described is an improved method and mechanism for accessing data within an XML document. One advantage of this approach is that if the document is schema based, access to a node of the XML document can be obtained by directly accessing the underlying column in which that node is stored as opposed to traversing a larger subset of the document. Moreover, this approach eliminates the need for datatype conversions. This is a distinct advantage over conventional approaches in which the data would be mapped from the datatype to a string for storage and later from a string to the datatype during retrieval. In addition, the present approach exploits the storage information to provide “direct” access to data based on offset in lieu of a linear traversal. Another advantage of this approach, e.g., the bean-style access, is that only the relevant portions need to be even loaded into memory. i.e. enables better lazy manifestation. For example, if the element of interest is the last child of the parent, the present bean accessor method will avoid having to traverse through all the previous children.

System Architecture Overview

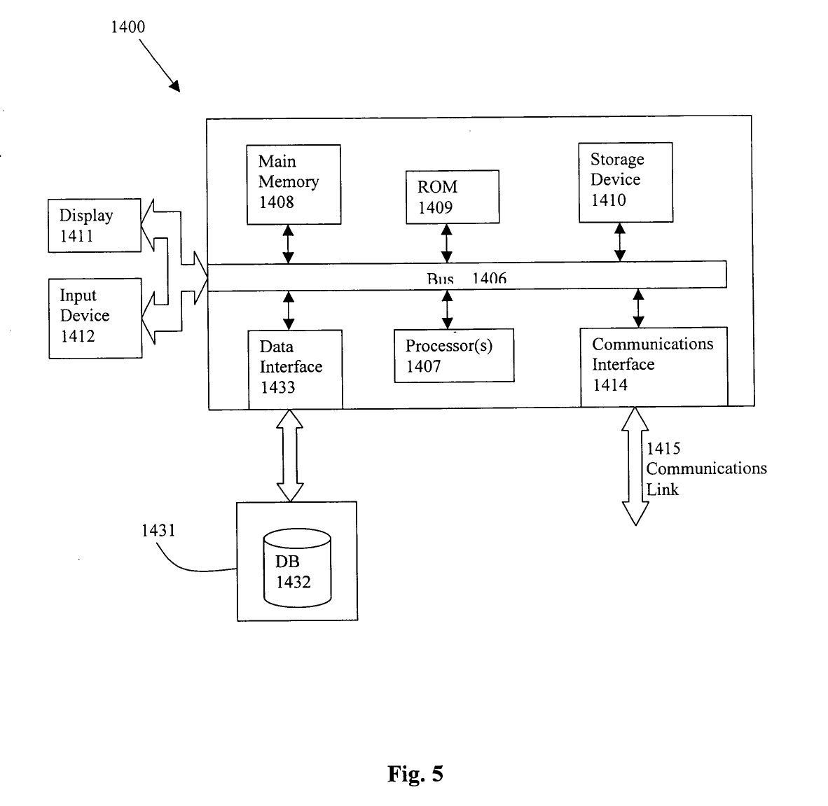

The execution of the sequences of instructions required to practice the invention may be performed in embodiments of the invention by a computer system 1400 as shown in FIG. 5. As used herein, the term computer system 1400 is broadly used to describe any computing device that can store and independently run one or more programs. In an embodiment of the invention, execution of the sequences of instructions required to practice the invention is performed by a single computer system 1400. According to other embodiments of the invention, two or more computer systems 1400 coupled by a communication link 1415 may perform the sequence of instructions required to practice the invention in coordination with one another. In order to avoid needlessly obscuring the invention, a description of only one computer system 1400 will be presented below; however, it should be understood that any number of computer systems 1400 may be employed to practice the invention.

Each computer system 1400 may include a communication interface 1414 coupled to the bus 1406. The communication interface 1414 provides two-way communication between computer systems 1400. The communication interface 1414 of a respective computer system 1400 transmits and receives signals, e.g., electrical, electromagnetic or optical signals, that include data streams representing various types of information, e.g., instructions, messages and data. A communication link 1415 links one computer system 1400 with another computer system 1400. A computer system 1400 may transmit and receive messages, data, and instructions, including program, i.e., application, code, through its respective communication link 1415 and communication interface 1414. Received program code may be executed by the respective processor(s) 1407 as it is received, and/or stored in the storage device 1410, or other associated non-volatile media, for later execution.

In an embodiment, the computer system 1400 operates in conjunction with a data storage system 1431, e.g., a data storage system 1431 that contains a database 1432 that is readily accessible by the computer system 1400. The computer system 1400 communicates with the data storage system 1431 through a data interface 1433. A data interface 1433, which is coupled to the bus 1406, transmits and receives signals, e.g., electrical, electromagnetic or optical signals, that include data streams representing various types of signal information, e.g., instructions, messages and data. In embodiments of the invention, the functions of the data interface 1433 may be performed by the communication interface 1414.

Computer system 1400 includes a bus 1406 or other communication mechanism for communicating instructions, messages and data, collectively, information, and one or more processors 1407 coupled with the bus 1406 for processing information. Computer system 1400 also includes a main memory 1408, such as a random access memory (RAM) or other dynamic storage device, coupled to the bus 1406 for storing dynamic data and instructions to be executed by the processor(s) 1407. The main memory 1408 also may be used for storing temporary data, i.e., variables, or other intermediate information during execution of instructions by the processor(s) 1407. The computer system 1400 may further include a read only memory (ROM) 1409 or other static storage device coupled to the bus 1406 for storing static data and instructions for the processor(s) 1407. A storage device 1410, such as a magnetic disk or optical disk, may also be provided and coupled to the bus 1406 for storing data and instructions for the processor(s) 1407. A computer system 1400 may be coupled via the bus 1406 to a display device 1411, such as, but not limited to, a cathode ray tube (CRT), for displaying information to a user. An input device 1412, e.g., alphanumeric and other keys, is coupled to the bus 1406 for communicating information and command selections to the processor(s) 1407.

According to one embodiment of the invention, an individual computer system 1400 performs specific operations by their respective processor(s) 1407 executing one or more sequences of one or more instructions contained in the main memory 1408. Such instructions may be read into the main memory 1408 from another computer-usable medium, such as the ROM 1409 or the storage device 1410. Execution of the sequences of instructions contained in the main memory 1408 causes the processor(s) 1407 to perform the processes described herein. In alternative embodiments, hard-wired circuitry may be used in place of or in combination with software instructions to implement the invention. Thus, embodiments of the invention are not limited to any specific combination of hardware circuitry and/or software.

The term “computer-usable medium” or “computer-readable medium” as used herein, refers to any medium that provides information or is usable by the processor(s) 1407. Such a medium may take many forms, including, but not limited to, non-volatile, volatile and transmission media. Non-volatile media, i.e., media that can retain information in the absence of power, includes the ROM 1409, CD ROM, magnetic tape, and magnetic discs. Volatile media, i.e., media that can not retain information in the absence of power, includes the main memory 1408. Transmission media includes coaxial cables, copper wire and fiber optics, including the wires that comprise the bus 1406. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, and the invention can be performed using different or additional process actions, or a different combination or ordering of process actions. The specification and drawings are, accordingly, to be regarded in an illustrative rather than restrictive sense.

1. A method for implementing efficient access to XML data, comprising:
receiving a schema for the XML data;
identifying an element within the schema to associate with a named access procedure;
determining if the element identified is appropriate for association with the named access procedure; and
if the element identified is appropriate for association, then creating the named access procedure and associating the named access procedure with the element, the named access procedure providing direct access to the element within an instance of the XML data without requiring progressive traversal of child nodes.

2. The method of claim 1 in which the named access procedure is defined based upon analysis of the schema.

3. The method of claim 2 in which access parameters are used to define the named access procedure, the access parameters including offset information for the element.

4. The method of claim 1 in which the named access procedure is a procedure to get a value for the element or to set a value for the element.

5. The method of claim 1 in which the named access procedure performs a direct mapping to an intended datatype for the element.

6. The method of claim 5 in which a conversion to a string datatype is not performed when mapping to the intended datatype.

7. The method of claim 5 in which the mapping is to a close-matching datatype.

8. The method of claim 1 in which the element is not appropriate for association if it corresponds to a datatype of ‘ANY’ or is a node that is not defined in the schema.

9. The method of claim 1 in which the element is appropriate for association if it corresponds to a native datatype of the system in which the method is performed.

10. The method of claim 1 in which the named access procedure is implemented as a bean accessor type.

11. A method for performing efficient access to XML data, comprising:
identifying an element within an instance of the XML data to access;
determining if the element has been associated with a named access procedure corresponding to the element, the named access procedure providing direct access to the element within an instance of the XML data without requiring progressive traversal of child nodes;
if the element has been associated with the named access procedure, then using the named access procedure to access the element in the instance of the XML data; and
if the element has not been associated with the named access procedure, then using a DOM API to access the element in the instance of the XML data.

12. The method of claim 11 in which a schema for the XML data is known apriori and the named access procedure is based upon analysis of the schema.

13. The method of claim 11 in which the named access procedure performs a direct mapping to an intended datatype for the element.

14. The method of claim 11 in which other elements of the data not presently needed are not loaded into memory.

15. The method of claim 11 in which the element is at a known offset from a parent location.

16. The method of claim 15 in which the mapping of the known offset is managed independently of the XML data.

17. The method of claim 15 in which a memory layout associated with the XML data is maintained as a flat layout.

18. A method for implementing efficient access to data that is based on a mark-up language, in which the data associated with a schema, the data comprising a parent node and at least one child node, the method comprising:
receiving the schema for the data that is based on the mark-up language;
identifying a child node that is to be accessed within the data;
reviewing the schema to determine one or more access parameters relating to the child node; and
using the one or more access parameters to directly access the child node without requiring progressive traversal of child nodes.

19. The method of claim 18 in which the mark-up language is based on XML, HTML, or SGML.

20. The method of claim 18 in which the access parameters is based on offset position, data length, or datatype.

21. The method of claim 18 in which a named access procedure is defined to get a value for the child node or to set a value for the child node.

22. The method of claim 18 in which direct mapping is performed to an intended datatype for the child node.

23. The method of claim 18 in which the child node is not directly accessed if it corresponds to a datatype of ‘ANY’ or is a node that is not defined in the schema.

24. The method of claim 18 in which the child node is directly accessed if it corresponds to a native datatype of the system in which the method is performed.

25. The method of claim 18 in which direct access is performed to an offset location for the child node.

26. The method of claim 25 in which the child node is at a known offset from a location for the parent node.

27. The method of claim 26 in which a mapping of the known offset is managed independently of the data.

28. The method of claim 25 in which a memory layout associated with the data is maintained as a flat layout.

29. The method of claim 18 in which other child nodes not presently needed are not loaded into memory.

30. A system for implementing efficient access to XML data, comprising:
means for receiving a schema for the XML data;
means for identifying an element within the schema to associate with a named access procedure;
means for determining if the element identified is appropriate for association with the named access procedure; and
means for creating the named access procedure and associating the named access procedure with the element if the element identified is appropriate for association, the named access procedure providing direct access to the element within an instance of the XML data without requiring progressive traversal of child nodes.

31. A computer program product comprising a computer usable medium having executable code to execute a process for implementing efficient access to XML data, the process comprising:
receiving a schema for the XML data;
identifying an element within the schema to associate with a named access procedure;
determining if the element identified is appropriate for association with the named access procedure; and
if the element identified is appropriate for association, then creating the named access procedure and associating the named access procedure with the element, the named access procedure providing direct access to the element within an instance of the XML data without requiring progressive traversal of child nodes.

32. A system for performing efficient access to XML data, comprising:
means for identifying an element within an instance of the XML data to access;
means for determining if the element has been associated with a named access procedure corresponding to the element, the named access procedure providing direct access to the element within an instance of the XML data without requiring progressive traversal of child nodes;
means for using the named access procedure to access the element in the instance of the XML data if the element has been associated with the named access procedure; and
means for using a DOM API to access the element in the instance of the XML data if the element has not been associated with the named access procedure.

33. A computer program product comprising a computer usable medium having executable code to execute a process for performing efficient access to XML data, the process comprising:
identifying an element within an instance of the XML data to access;
determining if the element has been associated with a named access procedure corresponding to the element, the named access procedure providing direct access to the element within an instance of the XML data without requiring progressive traversal of child nodes;
if the element has been associated with the named access procedure, then using the named access procedure to access the element in the instance of the XML data; and
if the element has not been associated with the named access procedure, then using a DOM API to access the element in the instance of the XML data.

34. A system for implementing efficient access to data that is based on a mark-up language, in which the data associated with a schema, the data comprising a parent node and at least one child node, the method comprising:
means for receiving the schema for the data that is based on the mark-up language;
means for identifying a child node that is to be accessed within the data;
means for reviewing the schema to determine one or more access parameters relating to the child node; and
means for using the one or more access parameters to directly access the child node without requiring progressive traversal of child nodes.

35. A computer program product comprising a computer usable medium having executable code to execute a process for implementing efficient access to data that is based on a mark-up language, in which the data associated with a schema, the data comprising a parent node and at least one child node, the process comprising:
receiving the schema for the data that is based on the mark-up language;
identifying a child node that is to be accessed within the data;
reviewing the schema to determine one or more access parameters relating to the child node; and
using the one or more access parameters to directly access the child node without requiring progressive traversal of child nodes.
